(19) United States
(12) Patent Application Publication
(10) Pub. No.: US 2026/0341032 A1
(43) Pub. Date: Oct. 29, 2026

(54) SYSTEM AND METHOD FOR RECOGNIZING POSITION AND SHAPE OF CLUSTER FOR AUTONOMOUS DRIVING

(71) Applicants: HYUNDAI MOTOR COMPANY, Seoul (KR); Kia Corporation, Seoul (KR)

(72) Inventor: So Yeon JEON, Hwaseong-si (KR)

(73) Assignees: HYUNDAI MOTOR COMPANY, Seoul (KR); Kia Corporation, Seoul (KR)

(21) Appl. No.: 19/365,545

(22) Filed: Oct. 22, 2025

(30) Foreign Application Priority Data
Apr. 28, 2025 (KR) 10-2025-0055683

(51) Int. Cl. G06V 20/56; G06T 7/20; G06V 10/762; G06V 10/764

(52) U.S. Cl. CPC G06V 20/56; G06T 7/20; G06V 10/762; G06V 10/764; G06V 2201/07

(57) ABSTRACT

A method recognizing an object includes a first step for clustering the plurality of detection points into at least one cluster, determining whether the number of the detection points belonging to the cluster is greater than or equal to ‘n’, and determining whether an absolute velocity of the cluster is greater than or equal to a threshold value, by the AI module, a second step for estimating a heading angle of an object corresponding to the cluster, based on the absolute velocity or determining a constant heading angle, and for estimating a length and a width of the corresponding object based on a shape of distribution of the detection points, or determining a constant length and a constant width, by the AI module, and a third step for estimating a position of the cluster, based on P-Box information for the cluster.

### CROSS-REFERENCE TO RELATED APPLICATION

The present application claims the benefit of priority to Korean Patent Application No. 10-2025-0055683, filed in the Korean Intellectual Property Office on Apr. 28, 2025, the entire contents of which are incorporated herein by reference.

### FIELD OF THE PRESENT DISCLOSURE

The present disclosure relates to a system and a method for recognizing a position and a shape of a cluster for autonomous driving, and more particularly relates to a system and a method for estimating a position and a shape of a cluster for recognizing an object, based on a detection point from a radar sensor among autonomous driving sensors.

### BACKGROUND

Recently, as an autonomous vehicle is developed and commercialized, cases of using various sensors and artificial intelligence (AI) technologies to support an autonomous driving functions of a vehicle have been increased. For example, studies and researches have been developed on the type of an object in front of a vehicle moving, the distance between the object and the vehicle, or the type of an algorithm to be processed by the vehicle depending on situations for ensuring safety.

Accordingly, a vehicle sensor technology has been more advanced, and a vehicle has been increasingly disposed with high-performance sensors such as Light Detection and Ranging (LiDAR) to recognize a surrounding environment, Radio Detection and Ranging (RADAR) using a radio wave, an ultrasonic sensor, a fisheye camera to capture an image at 360 degrees, a multi-focal lens, or Global Positioning System (GPS).

As described above, as measurement results obtained from a plurality of sensors are aggregated, a vehicle having a super sensor may be implemented. In self-driving (autonomous driving), the concept of the super sensor may refer to a technology for more accurately recognizing a surrounding environment by aggregating measurement values from various sensors, instead of relying on an individual sensor, for the convenience or safety of vehicle driving. As the above technology is combined with an information and communications technology (ICT) and a cloud technology, a sensor necessary for autonomous driving and an AI algorithm related to the autonomous driving are targeted not only for one vehicle, but also for numerous vehicle units (Fleet of vehicles) to remotely accumulate data and train an AI server and a database, thereby increasing the reliability of the vehicle sensor in determination, which achieving an unprecedented level of advancement.

To this regard, attempts have been made to enhance the practicality of a radar serving as an autonomous driving sensor.

### BRIEF SUMMARY

The present disclosure has been made to solve the above-mentioned problems occurring in the related art while advantages achieved by the related art are maintained intact.

Various aspects of the present disclosure are directed to providing a system and a method for recognizing a position and a shape of a cluster for autonomous driving, and more particularly provides a system and a method for estimating a position and a shape of a cluster for recognizing an object based on a detection point from a radar sensor among autonomous driving sensors.

The technical problems to be solved by the present disclosure are not limited to the aforementioned problems, and any other technical problems not mentioned herein will be clearly understood from the following description by those skilled in the art to which the present disclosure pertains.

To solve an entire portion or at least a portion of the technical solution, the present disclosure may be implemented in various following aspects.

A first aspect of the present disclosure relates to a system for recognizing an object by an artificial intelligence (AI) module and an autonomous driving sensor, and a system for recognizing a position and a shape of a cluster for autonomous driving is suggested as the first aspect of the present disclosure. The system includes a processor to include, as a portion of the AI module, an object recognition module disposed in the processor to recognize the object present under a surrounding environment, based on a plurality of detection points which are input from the autonomous driving sensor, and a memory storing multiple pieces of detection point data which is input. The AI module includes a first step for clustering the plurality of detection points into at least one cluster, determining whether the number of the detection points belonging to the cluster is greater than or equal to ‘n’, and determining whether an absolute velocity of the cluster is greater than or equal to a threshold value, a second step for estimating a heading angle of an object corresponding to the cluster, based on the absolute velocity or determining a constant heading angle, and for estimating a length and a width of the corresponding object based on a shape of distribution of the detection points, or determining a constant length and a constant width, and a third step for estimating a position of the cluster, based on P-Box information for the cluster.

In a system for recognizing a position and a shape of a cluster for autonomous driving according to a second aspect of the present disclosure, the autonomous driving sensor includes at least one radar, and wherein the object is classified as being in a moving state, when the absolute velocity of the cluster is greater than or equal to the threshold value, and as being in a stopped state, when the absolute velocity of the cluster is less than the threshold value.

In a system for recognizing a position and a shape of a cluster for autonomous driving according to a third aspect of the present disclosure, the second step includes a step for estimating the constant heading angle, the constant length, and the constant width as a shape of the cluster, when the number of the detection points is less than ‘n’.

In a system for recognizing a position and a shape of a cluster for autonomous driving according to a fourth aspect of the present disclosure, the third step includes a step for estimating an average on coordinates of the detection points belonging to the cluster as the position of the cluster, when the number of the detection points is less than ‘n’.

In a system for recognizing a position and a shape of a cluster for autonomous driving according to a fifth aspect of the present disclosure, the second step includes a step for estimating the heading angle, the length, and the width, based on the distribution form of the detection point with respect to the cluster classified as being in the stopped state.

In a system for recognizing a position and a shape of a cluster for autonomous driving according to a sixth aspect of the present disclosure, the estimating of the length and the width of the corresponding object, based on the distribution form of the detection point is performed through following Equation 1,

$$Length = {l}_{1} + {l}_{2} \qquad [ Equation 1 ]$$

$$Width = {w}_{1} + {w}_{2}$$

$$( in which , {l}_{1} = {\{ max ( \{ \begin{matrix}{x}_{i}^{′} & if {x}^{′} \geq 0 \\ 0 & if {x}^{′} < 0\end{matrix} ) \}}_{i = 1}^{n} , {l}_{2} = {\{ max ( \{ \begin{matrix}\vert {x}_{i}^{′} \vert & if {x}^{′} < 0 \\ 0 & if {x}^{′} \geq 0\end{matrix} ) \}}_{i = 1}^{n} ,$$

$${w}_{1} = {\{ max ( \{ \begin{matrix}{y}_{i}^{′} & if {y}^{′} \geq 0 \\ 0 & if {y}^{′} < 0\end{matrix} ) \}}_{i = 1}^{n} , {w}_{2} = {\{ max ( \{ \begin{matrix}\vert {y}_{i}^{′} \vert & if {y}^{′} < 0 \\ 0 & if {y}^{′} \geq 0\end{matrix} ) \}}_{i = 1}^{n}$$

In a system for recognizing a position and a shape of a cluster for autonomous driving according to a seventh aspect of the present disclosure, the absolute velocity is determined through following Equation 2.

$$Cluster absolute velocity = cluster relative velocity ( i . e . , the above mentioned ( {v}_{x} , {v}_{y} ) + absolute velocity of the host vehicle , in which ( {v}_{x} , {v}_{y} ) has a relationship of \qquad [ Equation 2 ]$$

$$[ \begin{matrix}{v}_{r , 1} \\ {v}_{r , 2} \\ ⋮ \\ {v}_{r , N}\end{matrix} ] = [ \begin{matrix}cos ( {θ}_{1} ) & sin ( {θ}_{1} ) \\ cos ( {θ}_{2} ) & sin ( {θ}_{2} ) \\ ⋮ & ⋮ \\ cos ( {θ}_{N} ) & sin ( {θ}_{N} )\end{matrix} ] [ \begin{matrix}{v}_{x} \\ {v}_{y}\end{matrix} ] ,$$

v_{r,i} is a gaze velocity of an i-th detection point,
θᵢ is an azimuth angle of the i-th detection point, and (vₓ, v_{y}) represents relative speeds in a vertical direction and a horizontal direction of the cluster.

In a system for recognizing a position and a shape of a cluster for autonomous driving according to an eighth aspect of the present disclosure, the heading angle is estimated through following Equation 3,

$$Heading angle = arctan ( \frac{{v}_{abs , y}}{{v}_{abs , x}} ) \qquad [ Equation 3 ]$$

In a system for recognizing a position and a shape of a cluster for autonomous driving according to a ninth aspect of the present disclosure, the third step is performed through following Equation 4,

$${X}_{center point} = \frac{{V}_{1 , x} + {V}_{3 , x}}{2} \qquad [ Equation 4 ]$$

$${Y}_{center point} = \frac{{V}_{1 , y} + {V}_{3 , y}}{2} ,$$

and (in which V₁=ƒ(P_{cp}, w₁, l₁, θ), V₃=ƒ(P_{cp}, w₂, l₂), and
ƒ(point, width, length, heading angle) is a function for extracting four vertexes of a virtual rectangle having a length (Lenth), a width (Width), and a heading angle, based on the detection point of the cluster.

In a system for recognizing a position and a shape of a cluster for autonomous driving according to a tenth aspect of the present disclosure, an angle between P̅_̅{̅c̅p̅}̅P̅ᵢ̅ and an x axis is selected as a candidate of the heading angle through following Equation 5, and a heading angle (θᵢ) is estimated based on Pᵢ for minimizing the sum of distances between detection points, in relation to the cluster classified as being in the stopped state,

$${θ}_{i} ( Heading angle ) = arctan ( \frac{{y}_{i} - {y}_{closeat point}}{{x}_{i} - {x}_{closeat point}} ) , \qquad [ Equation 5 ]$$

$$Sum of distances between detection points = {\sum }_{i = 1}^{n - 2} {d}_{i} ( n : number of detection points ) , and$$

$$\hat{ι} = {arg min}_{i} ( {\sum }_{i = 1}^{n - 2} {d}_{i} ( n : number of detection points ) )$$

(in which P_{cp} is the closest point, Pᵢ is an i-th detection point, and the sum of the distances between the detection points is determined except for P_{cp} and Pᵢ).

Meanwhile, an eleventh aspect of the present disclosure relates to a method for recognizing a position and a shape of a cluster for autonomous driving, and the method includes a first step for clustering the plurality of detection points into at least one cluster, determining whether the number of the detection points belonging to the cluster is greater than or equal to ‘n’, and determining whether an absolute velocity of the cluster is greater than or equal to a threshold value, by the AI module, a second step for estimating a heading angle of an object corresponding to the cluster, based on the absolute velocity or determining a constant heading angle, and for estimating a length and a width of the corresponding object based on a shape of distribution of the detection points, or determining a constant length and a constant width, by the AI module, and a third step for estimating a position of the cluster, based on P-Box information for the cluster, by the AI module.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating an overall system to control a vehicle, to autonomously recognize an object and perform autonomous driving, according to an exemplary embodiment of the present disclosure;

FIG. 2 is a flowchart illustrating an overall algorithm for estimating a position and a shape of a cluster based on information about a point detected by a radar, according to an exemplary embodiment of the present disclosure;

FIG. 3 illustrates a view to explain a process for estimating a heading angle, based on an absolute velocity of an object moving (or in a moving state), according to an exemplary embodiment of the present disclosure;

FIG. 4 illustrates a view to explain a process for estimating a length and a width of a cluster, based on a distribution form of a detection point, according to an exemplary embodiment of the present disclosure;

FIG. 5 illustrates a view to explain a process for estimating a position of a cluster, based on a distribution form of a detection point, according to an exemplary embodiment of the present disclosure;

FIG. 6 illustrates a view to explain a process for estimating a heading angle, based on a distribution form of a detection point for an object in a stopped state, according to an exemplary embodiment of the present disclosure;

FIG. 7A, FIG. 7B, and FIG. 7C illustrate several exemplary situations easy to have an estimation error of a heading angle;

FIG. 8A and FIG. 8B are views to explain a process for assigning a weight to the estimation of a shape of a cluster, based on reliability determined for each detection point, according to an exemplary embodiment of the present disclosure; and

FIG. 9 is a block diagram illustrating a computing system for computation to control an autonomous driving vehicle and to determine an object recognition computation, according to an exemplary embodiment of the present disclosure.

### DETAILED DESCRIPTION

Hereinafter, various exemplary embodiments of the present disclosure will be described in detail with reference to accompanying drawings. In the following description, the same reference numerals will be assigned to the same components even though the elements are illustrated in different drawings. In addition, in the following description of an exemplary embodiment of the present disclosure, a detailed description of well-known features or functions will be ruled out in order not to unnecessarily obscure the gist of the present disclosure.

In describing the components of the exemplary embodiment according to an exemplary embodiment of the present disclosure, terms such as first, second, “A”, “B”, (a), (b), and the like may be used. These terms are merely intended to distinguish one component from another component, and the terms do not limit the nature, sequence or order of the constituent components. In addition, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

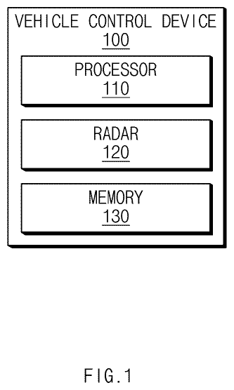

FIG. 1 is a block diagram illustrating an overall system to control a vehicle to autonomously recognize an object and perform autonomous driving.

Referring to FIG. 1, according to an exemplary embodiment of the present disclosure, a vehicle control device 100 may be disposed inside or outside a vehicle, and some of components included in the vehicle control device 100 may be disposed inside or outside the vehicle. In the instant case, the vehicle control device 100 may be disposed integrally with internal control units of the vehicle or may be disposed separately from the internal control units of the vehicle to be connected with the internal control units of the vehicle through a separate connector. For example, the vehicle control device 100 may further include components not illustrated in FIG. 1. For example, the vehicle control device (100) may include an autonomous driving control device, and the autonomous driving control device may control a drive motor or a steering wheel, etc., under the control of the processor.

According to an exemplary embodiment of the present disclosure, the vehicle control device 100 may include a processor 110, a LiDAR 120, and a memory 130. The processor 110, the LiDAR 120, and the memory 130 may be electronically and/or operably coupled with each other through an electronic component including a communication bus.

Hereinafter, the wording “the operably coupling between hardware devices” may include wired and/or wireless establishment of the direct connection between hardware devices and/or the indirect connection between hardware devices such that a second hardware device is controlled by a first hardware device.

Although the hardware devices are illustrated through different blocks, the exemplary embodiment is not limited thereto. For example, some of hardware devices in FIG. 1 may be included in a single integrated circuit including a system on a chip (SoC). The type and/or the number of hardware devices included in the vehicle control device 100 is not limited to that illustrated in FIG. 1. For example, the vehicle control device 100 may include some of hardware devices illustrated in FIG. 1.

According to an exemplary embodiment of the present disclosure, the vehicle control device 100 may include a hardware device to process data based on at least one instruction. For example, the hardware device to process data may include the processor 110. For example, the hardware device to process data may include an arithmetic and logic unit (ALU), a floating point unit (FPU), a field programmable gate array (FPGA), a central processing unit (CPU), and/or an application processor (AP). The processor 110 may have the architecture of a single-core processor, or may have the architecture of a multi-core processor including a dual-core, a quad-core, a hexa-core, or an octa-core.

According to an exemplary embodiment of the present disclosure, the processor 110 may include at least one of a graphic processing unit (GPU), a natural processing unit (NPU), or any combination thereof. For example, a GPU may be referred to as a visual processing unit (VPU). For example, the NPU may be referred to as a natural network processing unit.

According to an exemplary embodiment of the present disclosure, the vehicle control device 100 may include a depth sensor to detect an external object. For example, the depth sensor to detect the external object may include at least one of a time of flight (ToF) sensor, the LiDAR (light detection and ranging) 120, a structured light sensor, an ultrasonic sensor, an infrared sensor, a radar (radio detection and ranging; RADAR), an optical distance sensor, or any combination thereof. The following description will be made while focusing on a LiDAR.

According to an exemplary embodiment of the present disclosure, the vehicle control device 100 may include the LiDAR 120 to obtain a plurality of points, based on a pulse laser signal. For example, the LiDAR 120 may obtain data sets obtained by identifying a surrounding object around the vehicle control device 100 (or a vehicle including the vehicle control device 100). For example, the LiDAR 120 may identify at least one of a position of the surrounding object, the movement direction of the surrounding object, a velocity of the surrounding object, or any combination of the surrounding object, based on the pulse laser signal radiated from the LiDAR 120 and reflected back from the surrounding object.

For example, the LiDAR 120 may obtain data sets representing external objects which are present in a space formed by an x-axis, a y-axis, and a z axis, based on the pulse laser signal reflected from the surrounding object. For example, the LiDAR 120 may obtain the data sets including a plurality of points which are present in a space formed by the x-axis, the y-axis, and the z axis, based on the pulse laser signal received with a specific period. For example, the plurality of points may include points representing an external object in a three-dimensional (3D) virtual coordinate system. The 3D virtual coordinate system may include at least one of a vehicle coordinate system, a LiDAR coordinate system, or any combination thereof. However, the example of the 3D virtual coordinate system is not limited to the above description.

According to an exemplary embodiment of the present disclosure, the memory 130 of the vehicle control device 100 may include a hardware component to store data and/or an instruction input and/or output to and/or from the processor 110 of the vehicle control device 100. For example, the memory 130 may include a volatile memory including a random-access memory (RAM), and/or a non-volatile memory including a read-only memory (ROM).

For example, the volatile memory may include at least one of a dynamic RAM (DRAM), a static RAM (SRAM), a cache RAM, a pseudo SRAM (PSRAM), or any combination thereof. For example, the non-volatile memory may include at least one of a programmable ROM (PROM), an erasable PROM (EPROM), an electrically erasable PROM (EEPROM), a flash memory, a hard disk, a compact disk, a solid state drive (SSD), an embedded multi-media card (eMMC), or any combination thereof.

The memory 130 of the vehicle control device 100 may store at least one instruction indicating a calculation and/or operation to be performed based on the data by the processor 110 of the vehicle control device 100. The set of the at least one instruction may be referred to as a program, firmware, an operating system, a process, a routine, a sub-routine, and/or an application.

Hereinafter, installing an application inside the vehicle control device 100 refers to that at least one instruction provided in the form of an application is stored in the memory 130. In the instant case, the at least application may be stored in the format (a file with an extension specified by an operating system of the vehicle control device 100) executable by the processor 110 of the vehicle control device 100.

For example, the memory 130 may include a first neural network model to detect an object. For example, the memory 130 may include a second neural network model to output the type of a plurality of points and/or the score of the plurality of points obtained by the LiDAR 120.

According to an exemplary embodiment of the present disclosure, the processor 110 may obtain at least one of a first virtual box for expressing a target object, a first class for representing the type of the target object, or any combination thereof, based on the plurality of points obtained through the LiDAR 120 and the first neural network model stored in the memory 130.

According to an exemplary embodiment of the present disclosure, the processor 110 may obtain at least one of a first virtual box for expressing a target object, a first class for representing the type of the target object, or any combination thereof, based on inputting the plurality of points in the first neural network model. For example, the first neural network model may include an object detection model. For example, the target object may include an external object positioned within a specific distance from the vehicle control device 100 (or a host vehicle including the vehicle control device 100). For example, the target object may include an object identified and continuously tracked by the vehicle control device 100. For example, the type of the target object may include a plurality of types to classify the target object. For example, the type of the target object may include at least one of a first type for representing a ground plane, a second type for representing a type different from the ground plane, or any combination thereof. However, the type of the target object is not limited to the above description. For example, the type of the target object may include at least one of a third type for representing a person, a fourth type for representing a vehicle, or any combination thereof, but the present disclosure is not limited thereto.

According to an exemplary embodiment of the present disclosure, the processor 110 may obtain at least one of first partial points corresponding to at least a portion of the target object among the plurality of points, a second class for representing the type of the target object and identified through the first partial points, or any combination thereof, based on the plurality of points and the second neural network. For example, the second neural network model may include a segmentation model.

For example, the second neural network model may include a neural network model for obtaining the type of the plurality of points and the score of the plurality of points.

For example, the processor 110 may obtain first partial points, which correspond to at least a portion of the target object, among the plurality of points, based on inputting the plurality of points to the second neural network model. For example, the processor 110 may identify the type of the plurality of points, based on inputting the plurality of points to the second neural network model. For example, the processor 110 may obtain the first partial points, which correspond to at least a portion of the target object, among the plurality of points, based on the type of each of the plurality of points.

According to an exemplary embodiment of the present disclosure, the processor 110 may perform a first specified algorithm with respect to the plurality of points. For example, the processor 110 may perform the first specified algorithm with respect to the plurality of points, to classify the type of the plurality of points. For example, the processor 110 may classify second partial points, which correspond to a specified type, among the plurality of points. For example, the specified type may include the type for representing the ground plane.

For example, the processor 110 may classify the second partial points corresponding to the specified type, based on performing the first specified algorithm with respect to the plurality of points, and obtain (or identify) first partial points by excluding the second partial points from the plurality of points.

According to an exemplary embodiment of the present disclosure, the processor 110 may obtain at least one of a partial class for obtaining a second class, a score of each of the plurality of points, or any combination thereof, based on inputting the plurality of points to the second neural network model. For example, the processor 110 may obtain the partial class, and the score of each of the plurality of points, based on inputting the plurality of points to the second neural network model. For example, the partial class may include classifying each of a plurality of points into an arbitrary type.

For example, the processor 110 may fuse the partial class, the score of each of the plurality of points, and the second partial points. For example, the processor 110 may perform clustering based on the fusion of the partial class, the score of each of the plurality of points, and the second partial points. For example, the clustering may include grouping the first partial points corresponding to at least a portion of the target object.

For example, the processor 110 may obtain a point cloud for generating a second virtual box, based on the first partial points. For example, the processor 110 may obtain the point cloud, based on grouping the first partial points.

For example, the processor 110 may generate the second virtual box which represents a target object and are different from the first virtual box, based on the point cloud. For example, the second virtual box may include a box including at least a portion of the first partial points.

For example, the processor 110 may identify a heading direction for indicating the progressing direction of the target object, based on at least one of the first partial points, a point cloud, or any combination thereof.

For example, the processor 110 may identify the position of the second virtual box in a virtual coordinate system, based on at least one of the first partial points, the point cloud, or any combination thereof. For example, the processor 110 may identify the size of the second virtual box, based on at least one of the first partial points, the point cloud, or any combination thereof. For example, the processor 110 may identify the second class, based on at least one of the first partial points, the point cloud, or any combination thereof. For example, the processor 110 may identify at least one of the heading direction for indicating the direction of progress of the target object, the position of the second virtual box in the virtual coordinate system, the size of the second virtual box, the second class, or any combination thereof, based on at least one of first partial points, the point cloud, or any combination thereof. For example, the processor 110 may identify the heading direction of the bounding box, based on at least one of the first virtual box, the first class, the heading direction of the second virtual box, the position of the second virtual box, the size of the second virtual box, the second class, or any combination thereof. For example, the processor 110 may identify the position of the bounding box in the virtual coordinate system, based on at least one of the first virtual box, the first class, the heading direction of the second virtual box, the position of the second virtual box, the size of the second virtual box, the second class, or any combination thereof. For example, the processor 110 may obtain the third class for representing the type of the target object corresponding to the bounding box, based on at least one of the first virtual box, the first class, the heading direction of the second virtual box, the position of the second virtual box, the size of the second virtual box, the second class, or any combination thereof. For example, the processor 110 may obtain the heading direction of the bounding box, the position of the bounding box in the virtual coordinate system, the third class for representing the type of the target object corresponding to the bounding box, or any combination thereof, based on at least one of the first virtual box, the first class, the heading direction of the second virtual box, the position of the second virtual box, the size of the second virtual box, the second class, or any combination thereof.

For example, the processor 110 may assign a first identifier to the second virtual box to track the second virtual box. For example, the processor 110 may assign a second identifier, which corresponds to the first identifier, to the bounding box.

For example, the processor 110 may track the bounding box using the second identifier. For example, the processor 110 may track the target object, based on identifying a plurality of bounding boxes, which includes the bounding box assigned with the second identifier, from a plurality of frames. For example, the second identifier is assigned to the bounding box corresponding to the target object. Accordingly, the processor 110 may track the target object, by identifying a plurality of bounding boxes assigned with the second identifier, from the plurality of frames.

According to an exemplary embodiment of the present disclosure, the processor 110 may output the bounding box corresponding to the target object, based on at least one of the first virtual box, the first class, the first partial points, the second class, or any combination thereof. For example, the bounding box may include an example of representing the target object in a form of a hexahedron, on a virtual coordinate system.

Hereinafter, operations performed by a CPU, a GPU, and/or an NPU included in the processor 110 will be described.

According to an exemplary embodiment of the present disclosure, the processor 110 may include at least one of the CPU, the GPU, the NPU, or any combination thereof. For example, the at least one of the CPU, the GPU, the NPU, or any combination thereof may obtain the first virtual box and the first class, based on the first neural network model. For example, the at least one of the GPU or the NPU may obtain the first virtual box and the first class. For example, the at least one of the CPU, the GPU, the NPU, or any combination thereof may obtain the score of each of the partial class and the plurality of points to obtain the second class, based on the second neural network model. For example, the at least one of the GPU or the NPU may obtain the score of each of the partial class and the plurality of points to obtain the second class, based on the second neural network model. For example, the CPU may classify the second partial points, which correspond to the specific type, of the plurality of points, based on performing the first specific algorithm, which is for classifying a type of each of the plurality of points, with respect to the plurality of points.

As described above, according to an exemplary embodiment of the present disclosure, the vehicle control device 100 may include at least one processor 110. The vehicle control device 100 may accurately detect the target object by detecting the target object using at least one processor 110. In addition, the vehicle control device 100 may reduce the load on each processor, by performing a parallel process.

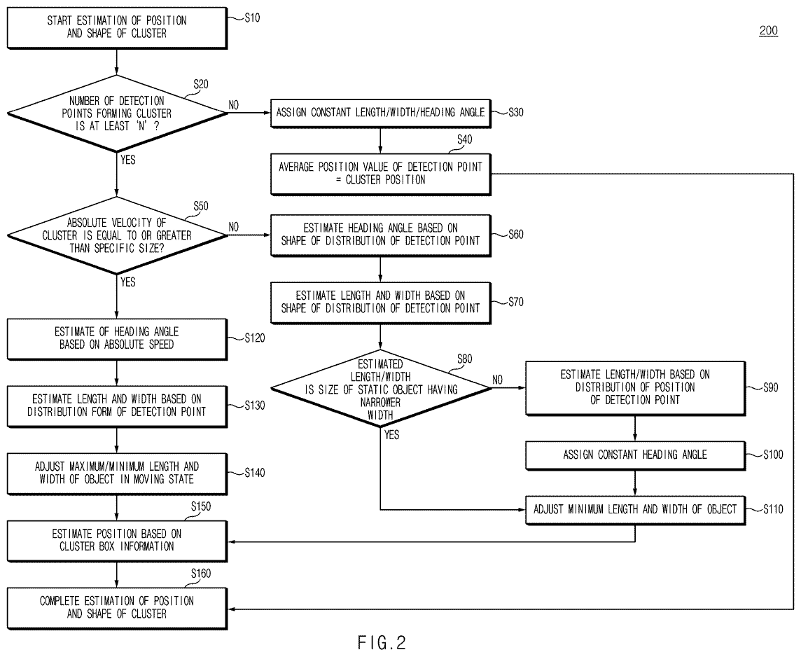

Meanwhile, before the description made with reference to FIG. 2, the recognition of a LiDAR-based object will be additionally described, for the overall comprehension about the recognition of the AI object.

An object recognition process by the LiDAR 120 and the AI module is performed through three steps for performing a pre-processing step, a segmentation step, and a tracking step.

A system 1000 for recognizing the object according to an exemplary embodiment of the present disclosure undergoes a pre-processing procedure before performing an object recognition function. The pre-processing process may include an operation for removing, for example, points forming the ground plane, based on laser sensing data (that is, unprocessed raw data) input from the LiDAR 120. A certain object may be misrecognized as being present even on the ground plane by a laser beam reflected from the ground plane. Accordingly, a process for distinguishing between the ground plane and things other than the ground plane is performed in the pre-processing step. If necessary, the process for distinguishing between the ground plane and the things other than the ground plane may be performed even in the segmentation step.

For example, in recognizing the AI object, the pre-processing process may be understood as a process for removing noise from a LiDAR point cloud image and reducing the total number of points, which are present in the LiDAR point cloud image, for example, through a voxel downsampling technique, by an image processing tool of an AI module which is provided in the process 110, thereby enhancing computational efficiency.

For reference, the LiDAR point cloud image may be expressed in a Bird's Eye View (BEV) format. The LiDAR map is formed to look like a scene viewed from eyes of a bird flying over an urban area. In the instant case, the LiDAR map is referred to as a BEV image.

In other words, the LiDAR 120 transmits a laser beam to a surrounding environment and records a time at which each laser beam is reflected from an external object and returned, thereby forming a point for each of numerous laser signals and determining the distance to the point, as described above. In such a manner that, as the numerous laser beams are repeatedly transmitted, the processor 110 may generate a real-time LiDAR map for the surrounding environment in a form of a 3D map in the BEV format or a two dimensional (2D) map if necessary.

A line or a surface in black and white on the LiDAR point cloud image actually includes numerous points (each point is generated by the laser beam of the LiDAR 120). Accordingly, a LiDAR sensing image is referred to as the LiDAR point cloud image. In addition, when an RGB-D (Red, Green, Blue-Depth) sensor and the LiDAR sensor are combined, the LiDAR point cloud image may be realized as a colored image.

A human being is hard to recognize a thing only using individually each of numerous points in the LiDAR point cloud image. However, for example, the human being may substantially guess a situation of a surrounding environment of the vehicle during the autonomous driving, when totally considering the point cloud through a manner such as the BEV format or a 2-D plan view. Furthermore, for example, a vehicle, a bus, a pedestrian, a roadside tree, or a traffic sign, which is present in the LiDAR point cloud image, may be recognized. According to the AI image recognizing technology, such a thing or a person may be referred to as an object, and may be classified into a class, such as a vehicle class, or a bus class, which belongs to a group having a specific characteristic for each object.

To identify an object belonging to the vehicle class or the bus class in the LiDAR point cloud image, the help of a deep AI neural network is required. AI training needs to be preceded to find objects in the LiDAR point cloud image and identify the class for the object through the AI neural network.

For example, a dataset called PANDASET™ (Dataset; Source, https://pandaset.org/#data-collection) contains over 48,000 camera images (mainly images taken in the Silicon Valley area of the United States) and over 16,000 LiDAR scan images. The above images have 28 classes in the form of annotations, in which the 28 classes include a pedestrian, a passenger car, a bicycle, a construction site sign, and a traffic sign.

In addition, the LiDAR point cloud image may be visualized to meet an option desired by a user through a point cloud work tool such as Open3D™ (source; https://www.open3d.org/). The LiDAR 120 is configured to detect a distance. Accordingly, for example, the LiDAR 120 may reproduce the 3D LiDAR image to be more realistically, by expressing a thing, which is present at a longer distance, in deep blue color, or a thing, which is present at a shorter distance, in light blue in visualizing in Open3D™.

In addition, as described above, an original LiDAR image (that is, Raw Data) may be pre-processed by applying a technology called Voxel (3D pixel) downsampling to the LiDAR point cloud image. In the instant case, Voxel refers to a cube-shaped 3D pixel, and Voxel downsampling is a technology for reducing the number of points to prevent excessive AI operations while maintaining the structure of various objects included in the LiDAR point cloud.

Meanwhile, the LiDAR 120 irradiates, for example, ‘m’ laser beams ‘n’ times during one scan cycle, wherein the ‘n’ is an integer number. In the instant case, the scan value of the laser beam, which collides with the external object and returns, forms a (m×n) matrix, which is called a range image. Each point forming the LiDAR point cloud image includes depth information (that is, a range), and further includes an intensity, an azimuth, an inclination, and other additional data of the returned laser pulse. Regarding range images, AI learning is possible using a large amount of datasets such as Waymo™ Open Dataset (WOD).

Range View (RV) is a technique which transforms a 3D point cloud into a 2D or 2.5D scene and expresses the 3D point cloud as a LiDAR 3D map, such as an analog picture, intuitively understood by a human being. The 3D LiDAR point cloud image has 2D coordinates in the range view. However, the 3D laser-related information (an angle, a slope, or an intensity) recorded when obtaining the range image is not discarded. Coordinates on one axis in 2D are obtained by applying a variable of a width to (x, y) coordinates of the (x, y, z) coordinate values of the 3D LiDAR image, and coordinates on another axis in 2D are obtained by applying range image information, which represents a range (depth), and a variable of a height to a (z) coordinate, thereby making a 2D range view image.

In addition, the AI algorithm according to an exemplary embodiment of the present disclosure may include a convolutional neural network (CNN). The CNN is an AI training module often employed to extract a feature (or a feature point) from the image data. To this end, a dataset of tens of thousands of commercially available images is present. Currently, CNN has versions which may process images from 1D to 3D. In other words, the results of the range view image processing tool are learned by the CNN neural network to help AI accurately recognize objects in the image.

Since an object around an autonomous vehicle is recognized by machine, an operation for generating a GT Bounding Box on a LiDAR map, which is described above, is an important process for recognizing the object. In machine learning, ground truth (GT) is a term used to indicate a source to a real value of data to be trained by AI. The GT bounding box, which is a bounding box having a box-type boundary, may be a kind of an image annotation applied to the LiDAR point cloud image.

Various objects are grouped using labels such that the AI module recognizes an object. In addition, the distance is set between the 3D data points used to output the GT bounding box. In the instant case, one GT bounding box may be including 50 LiDAR cloud points to 1,000 LiDAR cloud points.

In the instant case, the GT annotation is absent in the raw data, which is captured by a sensor, such as the LiDAR 120, during the vehicle driving. The processor 110 recognizes a target, which belongs to various classes such as a road sign, a crosswalk, a pedestrian, another vehicle, or a central line, as an object. The GT annotation is used to measure an object recognition error by comparing a recognition result, which is determined as an object through the AI algorithm, with a real object and to evaluate AI performance. The GT bounding box, which is applied to the source image, in a form of an annotation may be manually set by a user. However, a representative commercial GT calculation tool, such as Grid-striding, may be used.

Meanwhile, when an AI object recognition module is driven, a prediction bounding box may be recognized. A result recognized by the processor 110 as an object belonging to a specific class based on source image data obtained from the LiDAR 120 is represented in a form of another bounding box which is similar to the GT bounding box. The prediction bounding boxes are computation results of the autonomous driving AI, which is different from the GT bounding box. The prediction bounding box may be matched with the GT bounding box. However, the prediction bounding box fails to be matched with the GT bounding box, or may have no overlap region with the GT bounding box.

For reference, an object, which belongs to a specific class, may not be determined as actually existing at a certain position only using the prediction bounding boxes. Accordingly, the prediction bounding boxes are substantially referred to as a probability box (P-BOX) or a predicted bounding box.

The segmentation step performed after the pre-processing step refers to, for example, expressing a specific part of a road (for example, a traffic light), for example, in red, and expressing a reaming portion (an asphalt road) of the road in blue. In the segmentation step, point clouds are clustered in a specific group, and a P-Box is generated. For reference, there is a technology of cluster expansion. According to the cluster expansion technology, the target of the expansion may include a cluster of all points, which includes a seed point, within an epsilon (the minimum distance for forming the cluster) distance.

In the segmentation step, clustering and P-Box generating are performed, based on the point cloud. For example, the AI network to perform the segmentation step is used to obtain a point label from the LiDAR 120.

According to an exemplary embodiment of the present disclosure, to solve the ground plane recognition error caused in the segmentation step, a “rule-based” road surface recognition technique and a label fusion technique are suggested. An algorithm (hereinafter, a rule-based algorithm) for the rule-based road surface recognition technique may typically employ any of a variety of techniques, such as a slope-based road surface recognition technique, a grid-based road surface recognition technique, and other non-planar-based road surface recognition techniques. However, according to an exemplary embodiment of the present disclosure, the slope-based road recognition technique should be employed when the road surface is recognized inside a tunnel.

For reference, the semantic segmentation technique is a work for attaching an intrinsic class label to each point in the point cloud generated by the LiDAR 120. The semantic segmentation in the LiDAR image processing technology is a technology which finds and uses meaningful information from LiDAR data for object recognition or scene reproduction required to implement autonomous driving. Various semantic segmentation AI models including a projection-based method, a point-based method, and a sporadic convolution-based method are conventionally provided. For example, the result of the semantic segmentation may be the result of an AI operation performed by the processor 110 together an NVIDIA DRIVE™ AGX system. Accordingly, such a configuration may apply various colors to, for example, the LiDAR point cloud image.

The LiDAR image undergoes a post-processing procedure after the segmentation step as described above. The post-processing procedure refers to the transformation of point cloud data into a 3D map or modeling, which is information meaningful for autonomous driving. The post-processing procedure also includes the process for finally removing noise or errors from the LiDAR point cloud image, for recognizing an object, such as a vehicle or a pedestrian, from the point cloud, and attaching an intrinsic identifier to the point cloud information if necessary such that the point cloud information is registered.

FIG. 2 is a flowchart illustrating an overall algorithm 200 for estimating a position and a shape of a cluster based on information about a point detected by a radar, according to an exemplary embodiment of the present disclosure.

Referring to FIG. 2, in ‘S10’, the estimation for the position and the shape of the cluster starts according to an exemplary embodiment of the present disclosure. A process for classifying a cluster is performed depending on the number of detection points in ‘S20’, and performed depending on whether the object is moved or stopped in ‘S50’. In other words, ‘S20’ and ‘S50’ are to measure the information about the position and the shape based on the characteristic of the cluster. The input for the determination of ‘YES’/‘No’ in ‘S20’ is the number of the detection points forming the cluster, and the input for the determination of ‘YES’/‘No’ in ‘S50’ is the absolute velocity of the cluster.

Information about classification of the cluster is output depending on the determination result in ‘S20’. When the cluster is classified based on the number of the detection points forming the cluster as in ‘S20’, the classification of the cluster may be determined based on the density of input data from the radar sensor. For example, when the detection points are sparsely input, the reference number (‘n’) for determining ‘YES/NO’ in step S20 may be adjusted to be smaller, and when the density is high due to a large number of detection points, the reference number (‘n’) may be adjusted to be larger.

When the number of the detection points forming the cluster is less than ‘n’ based on the determination result in ‘S20’, the determination of ‘NO’ is made to move to ‘S30’, and a constant length/width/heading angle is applied to the relevant cluster. The cluster location is determined as an average value on the points of the detection points in ‘S40’. Thereafter, ‘S160’ is performed to complete the process for estimating the position and the shape of the cluster according to an exemplary embodiment of the present disclosure.

In other words, ‘S30’ is a process for estimating the shape with respect to an object, which makes it difficult to estimate the shape of the cluster, as the number of detection points for forming the cluster is small, and ‘S40’ is a process for estimating the position of such an object, subsequently to ‘S30’. A detection point for an object stopped to make it difficult to specify a shape forms several small clusters to be utilized in determining whether the object is present at a relevant position, even though the object is not specified individually. For example, the object having a significantly small size may be assigned with the constant heading angle/length/width (for example, the heading angle=0 degree; length=0.5 m; width=0.5 m) in ‘S30’.

For reference, even if an object having a larger size forms a smaller cluster, instead of a larger cluster, the smaller cluster may be utilized to determine whether the object is present at a relevant position. For example, even if guiderails and walls at left and right sides of the host vehicle are not estimated as belonging to one cluster, the guiderails and walls at left and right sides of the host vehicle are estimated as belonging to several small clusters. Accordingly, it may be at least determined that an obstacle or a surrounding object is present at a relevant position.

Whether the absolute velocity of the cluster is greater than or equal to a specific size is determined in ‘S50’. When the absolute velocity of the cluster is greater than or equal to the specific size to show a “moving state”, steps under ‘S120’ in the flowchart are performed to estimate the position and the shape of the object.

First, in ‘S120’, the heading angle is estimated. In the instant case, a heading angle of an object in the moving state is estimated based on the absolute velocity of the object, because velocity information of radar input data is based on Doppler's Principle with higher reliability. In the instant case, the absolute velocity of the cluster may be calculated through following Equation 1, based on the distribution of the radial velocity of the detection points forming the cluster.

$$[ \begin{matrix}{v}_{r , 1} \\ {v}_{r , 2} \\ ⋮ \\ {v}_{r , N}\end{matrix} ] = [ \begin{matrix}cos ( {θ}_{1} ) & sin ( {θ}_{1} ) \\ cos ( {θ}_{2} ) & sin ( {θ}_{2} ) \\ ⋮ & ⋮ \\ cos ( {θ}_{N} ) & sin ( {θ}_{N} )\end{matrix} ] [ \begin{matrix}{v}_{x} \\ {v}_{y}\end{matrix} ] \qquad < Equation 1 >$$

In the instant case,
v_{r,i} is the gaze velocity of an i-th detection point,
θᵢ is an azimuth angle of the i-th detection point, and (vₓ, v_{y}) represents relative velocities in a vertical direction and a horizontal direction of the cluster.

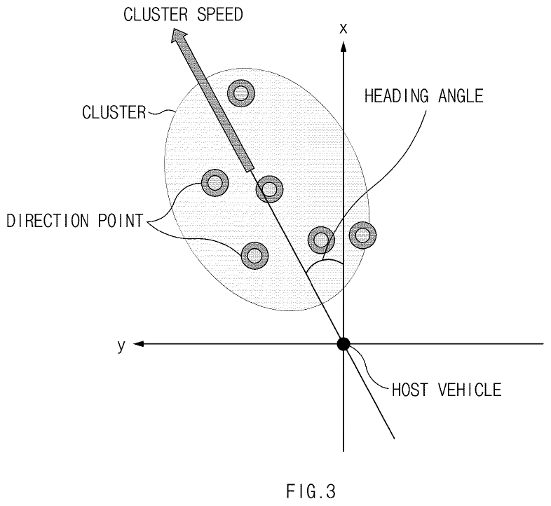

The process for estimating the heading angle based on the absolute velocity in ‘S120’ may be understood with reference to FIG. 3. FIG. 3 illustrates a view to explain a process for estimating a heading angle, based on the absolute velocity of an object moving (or in a moving state), according to an exemplary embodiment of the present disclosure.

In step S120, the absolute velocity (or cluster absolute velocity) of the cluster refers to the cluster's own velocity and is independent of the velocity of the host vehicle, which is driving with a radar 120, so the cluster absolute velocity is determined as shown in following Equation 1-1.

Cluster absolute velocity cluster relative velocity (i.e., the above described (vₓ,v_{y})+absolute velocity of the host vehicle <Equation 1-1>

In FIG. 3, a two-dimensional host vehicle reference coordinate system (x, y) indicates that the absolute velocity of the host vehicle in Equation 1-1 is added to the absolute velocity of the cluster.

Next, when following Equation 2 is applied to an x-axis component and a y-axis component of the absolute velocity of the cluster found as described above, the heading angle may be found based on the absolute velocity in ‘S120’.

$$Heading angle = arctan ( \frac{{v}_{abs , y}}{{v}_{abs , x}} ) \qquad < Equation 2 >$$

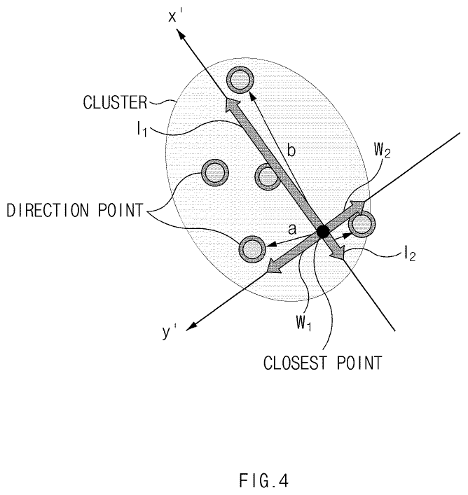

Next, in ‘S130’, the length and the width are estimated based on a distribution form of the detection points. The details thereof will be described with reference to FIG. 4. FIG. 4 illustrates a view to explain a process for estimating the length and the width of the cluster, based on the distribution form of the detection points, according to an exemplary embodiment of the present disclosure.

In other words, in ‘S130’, the length and the width related to the shape of the position and the shape of the object in the moving state are determined as illustrated in FIG. 4. ‘S130’ is a process for estimating the length and the width, based on the heading angle of the cluster, which is estimated based on the absolute velocity of the detection point, and the distribution form of the detection point. As illustrated in FIG. 4, the length and the width are estimated as the maximum horizontal distance and the maximum vertical distance which are obtained among distances from the closest point to detection points, which are included in a cloud, along a heading direction axis (that is, an x′ axis) and a vertical axis (that is, an y′ axis).

In ‘S130’, the length (Lenth) and the width (Width) of the cluster are estimated based on the distribution form of the detection point, through the following Equations 3 and 3-1.

$$Length = {l}_{1} + {l}_{2} \qquad < Equation 3 >$$

$$Width = {w}_{1} + {w}_{2} \qquad < Equation 3 - 1 >$$

$${l}_{1} = {\{ max ( \{ \begin{matrix}{x}_{i}^{′} & if {x}^{′} \geq 0 \\ 0 & if {x}^{′} < 0\end{matrix} ) \}}_{i = 1}^{n} , {l}_{2} = {\{ max ( \{ \begin{matrix}\vert {x}_{i}^{′} \vert & if {x}^{′} < 0 \\ 0 & if {x}^{′} \geq 0\end{matrix} ) \}}_{i = 1}^{n} ,$$

$${w}_{1} = {\{ max ( \{ \begin{matrix}{y}_{i}^{′} & if {y}^{′} \geq 0 \\ 0 & if {y}^{′} < 0\end{matrix} ) \}}_{i = 1}^{n} , {w}_{2} = {\{ max ( \{ \begin{matrix}\vert {y}_{i}^{′} \vert & if {y}^{′} < 0 \\ 0 & if {y}^{′} \geq 0\end{matrix} ) \}}_{i = 1}^{n}$$

The estimated length and the estimated width in ‘S130’ are adjusted based on information about the maximum length and the minimum length of the object in the moving state and information about the width of the object in the moving state in ‘S140’.

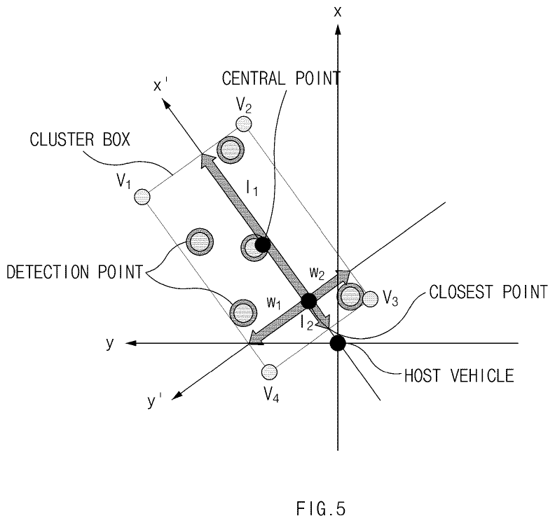

Next, in ‘S150’, the position of the cluster is estimated based on information (or cluster box information) about a cluster box. ‘S150’ may be visually understood using FIG. 5. FIG. 5 illustrates a view to explain a process for estimating the position of the cluster, based on the distribution form of the detection point, according to an exemplary embodiment of the present disclosure.

In other words, in ‘S150’, the center point (see FIG. 5) among four vertices V₁, V₂, V₃, V₄ of a cluster box (see FIG. 5) estimated based on the distribution form of the detection points is estimated as the position of the cluster through following Equations 4 and 4-1. According to an exemplary embodiment of the present disclosure, a function ƒ(point, width, length, heading angle) is to extract the vertexes of a rectangular box having the width, the length, or the heading angle, based on the point.

$${X}_{center point} = \frac{{V}_{1 , x} + {V}_{3 , x}}{2} \qquad < Equation 4 >$$

$${Y}_{center point} = \frac{{V}_{1 , y} + {V}_{3 , y}}{2}$$

$${V}_{1} = f ( {P}_{cp} , {w}_{1} , {l}_{1} , θ ) \qquad < Equation 4 - 1 >$$

$${V}_{3} = f ( {P}_{cp} , {w}_{2} , {l}_{2} )$$

After ‘S150’, the shape (length and width), the position, and the heading angle of the object in the moving state in ‘S120’ to ‘S150’ are completely determined in ‘S160’.

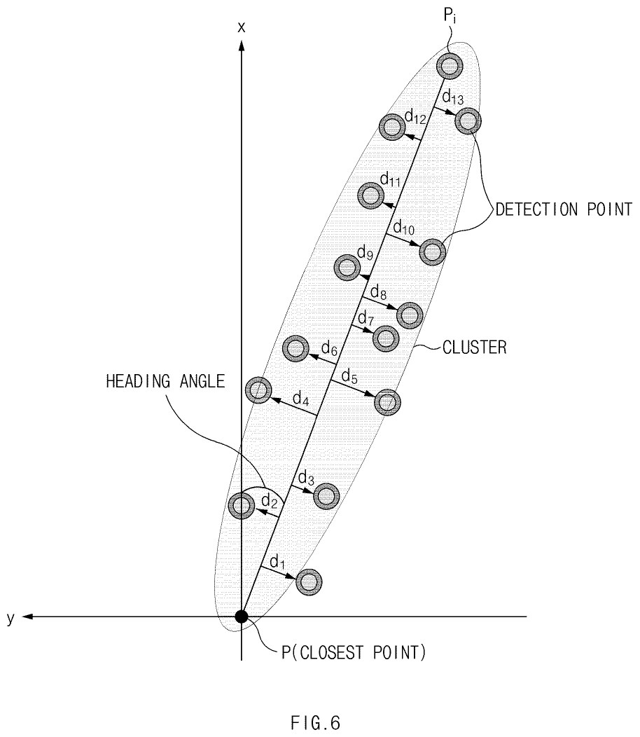

Returning back to ‘S50’ in FIG. 2, when the absolute velocity of the cluster is less than the specific size in ‘S50’, the determination of ‘NO’ is made with respect to an object to be classified as being in a ‘stopped state’, and ‘S60’ to ‘S110’ are performed. The following description will be made with reference to FIG. 6. FIG. 6 illustrates a view to explain a process for estimating a heading angle, based on the distribution form of the detection point for the object in a stopped state, according to an exemplary embodiment of the present disclosure.

In subsequent steps from ‘S60’, the position and the shape of the object in a lower velocity state, in which the velocity of the cluster is at most a specific size) or in the stopped state (in the present specification, the lower velocity state and the stopped state are collectively referred to as the “stopped state”) are estimated. Among them, ‘S60’ is to estimate the heading angle.

In other words, in ‘S60’, the heading angle is estimated based on a distribution form of the detection point. In the instant case, for the object estimated as having a narrower width in the distribution form of the detection point, the heading angle is estimated depending on the distribution form of the detection point.

First, as illustrated in FIG. 6, the angle between P_{cp}Pᵢ and the x axis is selected as a candidate of the heading angle through following Equation 5.

$${θ}_{i} ( Heading angle ) = arctan ( \frac{{y}_{i} - {y}_{closeat point}}{{x}_{i} - {x}_{closeat point}} ) \qquad < Equation 5 >$$

Next, the sum of distances between detection points except for P̅_̅{̅c̅p̅}̅P̅ᵢ̅, P_{cp}, and Pᵢ is determined through following Equation 5-1.

$$Sum of distances between detection points = {\sum }_{i = 1}^{n - 2} {d}_{i} ( n : number of detection points ) \qquad < Equation 5 - 1 >$$

Next, θᵢ is selected through following Equation 5-2 based on Pᵢ making the sum of distances, which are found in Equation 5-1, to the minimum value.

$$\hat{ι} = {arg min}_{i} ( {\sum }_{i = 1}^{n - 2} {d}_{i} ( n : number of detection points ) ) \qquad < Equation 5 - 2 >$$

For the object (for example, the guiderail of the road) having a narrower width, the heading angle is determined as θᵢ estimated in ‘S60’. However, in ‘S80, it is determined whether the length/width estimated corresponds to the size of an object stopped and having a narrower width. For an object not narrower in width (that is, determined as ‘NO’ in ‘S80’), the length and the width are estimated based on the position distribution of the detection point in ‘S90’, and the constant heading angle is determined as the ‘heading angle’ in ‘S100’. When the object makes it difficult to distinguish the class of the object, only by use of the distribution form of the detection point, the constant heading angle is used based on the possibility of erroneous estimation of the heading angle. Thereafter, ‘S110’ is performed to adjust the computation result about the shape based on the minimum length and width of the object belonging to a specific class.

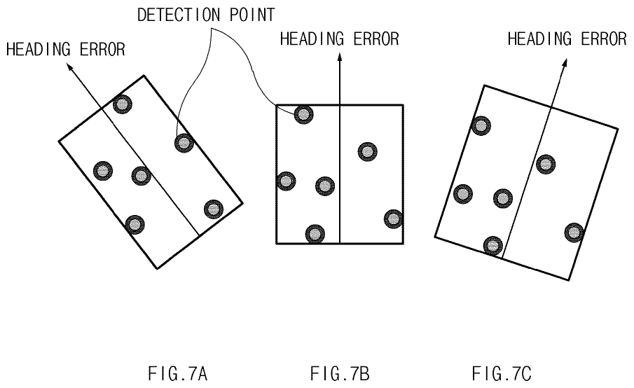

For reference, when the distribution form of the detection points in the stopped object having a cluster velocity of at most a specific size represents an object, such as a guiderail, estimated as being in a narrower shape, the heading angle is estimated based on the distribution form of the detection points. An object difficult to determine the type of the object only using the distribution form of the detection point is coped with the possibility of the estimation error, as a constant heading angle is assigned. The object difficult to determine the type of the object only using the distribution form of the detection point is illustrated in FIG. 7A, FIG. 7B, and FIG. 7C. In other words, FIG. 7A, FIG. 7B, and FIG. 7C illustrate several exemplary situations easy to have an estimation error of the heading angle.

Referring to FIG. 7A, FIG. 7B, and FIG. 7C, it may be recognized that the heading angle may not be specified with respect to the same detection point distribution, and the heading angle may be corrected in a radar tracking system.

The length and the width are estimated based on the distribution form of the detection point in ‘S70’ and the position distribution in ‘S90’, the object estimated based on the narrower form in the distribution of the detection point is estimated in length (Lenth) and width (Width) through Equation 3 and Equation 3-1 described above, based on the distribution form of the detection point (that is, ‘S70’ is applied)

In the instant case, the length and the width are estimated based on the standard deviation of the position of the detection point through following Equation 6, for the object difficult to determine the type of the object based on the distribution form of the detection point. In other words, Equation 6 is an equation to estimate the position of the cluster, based on a mean value of the detection point.

$${X}_{center point} = \frac{\sum {x}_{i}}{number of detectoin points} \qquad < Equation 6 >$$

$${Y}_{center point} = \frac{\sum {y}_{i}}{number of detectoin points}$$

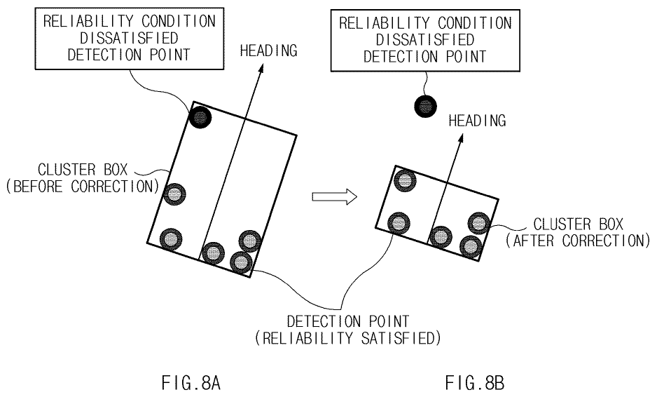

FIG. 8A and FIG. 8B illustrate views to explain a process for applying a weight to the estimation of a shape of a cluster based on reliability determined for each detection point, according to an exemplary embodiment of the present disclosure.

In FIGS. 8A and 8B, a detection point failed to satisfy the reliability condition is excluded from basis data for generating a cluster box through correction. As illustrated in FIG. 8B, the cluster box may be corrected to be smaller when compared to the cluster box illustrated in FIG. 8A.

As described above, according to an exemplary embodiment of the present disclosure, the position and the shape of the cluster, which is a set of points, may be estimated based on detection point data of the radar sensor.

In fact, according to the related art, although the radar sensor provides an output in a tracking form, the information has a limited size, and a situation deviating from a specific case is unstable. However, according to an exemplary embodiment of the present disclosure, the detection point is directly used instead of the track data of the radar sensor, such that the cluster information is generated. Accordingly, the more effective radio detection and ranging (RADAR) track estimation results may be generated in link to a tracking system using cluster information

Meanwhile, the radar sensor detects an object based on a Doppler effect. Accordingly, the detection rate for the object in the stopped state is degraded, and one object is split into several smaller objects to be output. For example, the detection result of the guiderail may be prevented from being output in the form of several tracks having a smaller size, instead of the track having a longer size.

The present disclosure suggests a technique for estimating shape information (length/width/heading angle) of a cluster for a point detected by a radar, a technique for estimating position information of the cluster for the point detected by the radar, a technique for estimating the shape information of the cluster for the point, or a technique for estimating position information of the cluster for the point. According to an exemplary embodiment of the present disclosure, the shape of the object in the stopped state is estimated. Accordingly, multiple pieces of data may not be processed with respect to the same object. The length/width/heading angle is not separately estimated, but estimated in a manner in which the estimated length/width is linked to the heading angle. Accordingly, the correlation and sustainability of the shape estimation results are high. In addition, the shape and the position are estimated in link to each other. Accordingly, the shape and the position of the cluster may be maintained highly.

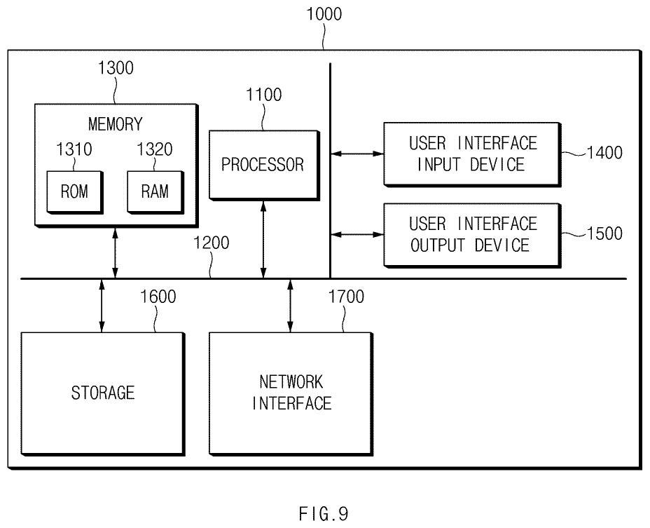

FIG. 9 is a block diagram illustrating a computing system 1000 for computation to control an autonomous driving vehicle and to determine an object recognition computation, according to an exemplary embodiment of the present disclosure.

Referring to FIG. 9, the computing system 1000 may include at least one processor 1100, a memory 1300, a user interface input device 1400, a user interface output device 1500, a storage 1600, and a network interface 1700, which are connected to each other via a bus 1200.

The processor 1100 may be a central processing unit (CPU) or a semiconductor device for processing instructions stored in the memory 1300 and/or the storage 1600. Each of the memory 1300 and the storage 1600 may include various types of volatile or non-volatile storage media. For example, the memory 1300 may include a read only memory (ROM) and a random access memory (RAM).

Thus, the operations of the methods or algorithms described in connection with the embodiments disclosed in the present disclosure may be directly implemented with a hardware module, a software module, or the combinations thereof, executed by the processor 1100. The software module may reside on a storage medium (that is, the memory 1300 and/or the storage 1600), such as a RAM, a flash memory, a ROM, an erasable and programmable ROM (EPROM), an electrically EPROM (EEPROM), a register, a hard disc, a removable disc, or a compact disc-ROM (CD-ROM).

The exemplary storage medium may be coupled to the processor 1100. The processor 1100 may read out information from the storage medium and may write information in the storage medium. Alternatively, the storage medium may be integrated with the processor 1100. The processor and storage medium may reside in an application specific integrated circuit (ASIC). The ASIC may reside in a user terminal. Alternatively, the processor and storage medium may reside as separate components of the user terminal.

According to an exemplary embodiment of the present disclosure, the position information and the shape information of the cluster, which is a set of the points, are estimated, based on data (detection point data) on a point detected by the radar.

In fact, according to the related art, although the radar sensor provides an output in a tracking form, the information has a limited size, and a situation deviating from a specific case is unstable. However, according to an exemplary embodiment of the present disclosure, the detected point is directly used instead of the track data of the radar sensor, such that the cluster information is generated. Accordingly, the more effective radar track estimation results may be generated in link to a tracking system using cluster information

Meanwhile, the radar sensor detects an object based on a Doppler effect. Accordingly, the detection rate for the object in the stopped state is degraded, and one object is split into several smaller objects to be output. For example, the detection result of the guiderail may be prevented from being output in the form of several tracks having a smaller size, instead of the track having a longer size.

The present disclosure suggests a technique for estimating shape information (length/width/heading angle) of a cluster for a point detected by a radar, a technique for estimating position information of the cluster for the point detected by the radar, a technique for estimating the shape information of the cluster for the point, or a technique for estimating position information of the cluster for the point. According to an exemplary embodiment of the present disclosure, the shape of the object in the stopped state is estimated. Accordingly, multiple pieces of data may not be processed with respect to the same object. The length/width/heading angle is not separately estimated, but estimated in a manner in which the estimated length/width is linked to the heading angle. Accordingly, the correlation and sustainability of the shape estimation results are high. In addition, the shape and the position are estimated in link to each other. Accordingly, the shape and the position of the cluster may be maintained highly

Besides, a variety of effects including the above effects are understood with reference to the detailed description and accompanying drawings by those skilled in the art.

The above description is merely an example of the technical idea of the present disclosure, and various modifications and modifications may be made by one skilled in the art without departing from the essential characteristic of the present disclosure.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A system for recognizing a position and a shape of a cluster for autonomous driving, and recognizing an object by an artificial intelligence (AI) module and an autonomous driving sensor, the system comprising:
a processor including, as a portion of the AI module, an object recognition module disposed in the processor to recognize the object present under a surrounding environment, based on a plurality of detection points which are input from the autonomous driving sensor; and
a memory storing multiple pieces of detection point data which is input,
wherein the AI module includes:
a first step for clustering the plurality of detection points into at least one cluster, determining whether a number of the detection points belonging to the cluster is greater than or equal to ‘n’, wherein the ‘n’ is an integer number, and determining whether an absolute velocity of the cluster is greater than or equal to a threshold value,
a second step for estimating a heading angle of the object corresponding to the cluster based on the absolute velocity or determining a constant heading angle, and for estimating a length and a width of the corresponding object based on a shape of distribution of the detection points, or determining a constant length and a constant width, and
a third step for estimating a position of the cluster, based on P-Box information for the cluster.

2. The system of claim 1,
wherein the autonomous driving sensor includes at least one radar, and
wherein the object is classified as being in a moving state, based on that the absolute velocity of the cluster is greater than or equal to the threshold value, and as being in a stopped state, based on that the absolute velocity of the cluster is less than the threshold value.

3. The system of claim 2, wherein the second step includes:
a step for estimating the constant heading angle, the constant length, and the constant width as a shape of the cluster, based on that the number of the detection points is less than ‘n’.

4. The system of claim 3, wherein the third step includes:
a step for estimating an average on coordinates of the detection points belonging to the cluster as the position of the cluster, based on that the number of the detection points is less than ‘n’.

5. The system of claim 2, wherein the second step includes:
a step for estimating the heading angle, the length, and the width, based on a distribution form of the detection point with respect to the cluster classified as being in the stopped state.

6. The system of claim 1, wherein the estimating of the length and the width of the corresponding object, based on a distribution form of the detection point is performed through following Equation 1,
$$Length = {l}_{1} + {l}_{2} \qquad [ Equation 1 ]$$
$$Width = {w}_{1} + {w}_{2}$$
$$( in which , {l}_{1} = {\{ max ( \{ \begin{matrix}{x}_{i}^{′} & if {x}^{′} \geq 0 \\ 0 & if {x}^{′} < 0\end{matrix} ) \}}_{i = 1}^{n} , {l}_{2} = {\{ max ( \{ \begin{matrix}\vert {x}_{i}^{′} \vert & if {x}^{′} < 0 \\ 0 & if {x}^{′} \geq 0\end{matrix} ) \}}_{i = 1}^{n} ,$$
$${w}_{1} = {\{ max ( \{ \begin{matrix}{y}_{i}^{′} & if {y}^{′} \geq 0 \\ 0 & if {y}^{′} < 0\end{matrix} ) \}}_{i = 1}^{n} , {w}_{2} = {\{ max ( \{ \begin{matrix}\vert {y}_{i}^{′} \vert & if {y}^{′} < 0 \\ 0 & if {y}^{′} \geq 0\end{matrix} ) \}}_{i = 1}^{n} .$$

7. The system of claim 1, wherein the absolute velocity is determined through following Equation 2,
$$Cluster absolute velocity = cluster relative velocity ( i . e . , the above mentioned {v}_{x} , {v}_{y} ) + absolute velocity of the host vehicle , \qquad [ Equation 2 ]$$
$$in which {v}_{x} , and {v}_{y} has a relationship of$$
$$[ \begin{matrix}{v}_{r , 1} \\ {v}_{r , 2} \\ ⋮ \\ {v}_{r , N}\end{matrix} ] = [ \begin{matrix}cos ( {θ}_{1} ) & sin ( {θ}_{1} ) \\ cos ( {θ}_{2} ) & sin ( {θ}_{2} ) \\ ⋮ & ⋮ \\ cos ( {θ}_{N} ) & sin ( {θ}_{N} )\end{matrix} ] [ \begin{matrix}{v}_{x} \\ {v}_{y}\end{matrix} ] , ‘ {v}_{r , i} ’$$
is a gaze velocity of an i-th detection point, θᵢ is an azimuth angle of the i-th detection point, and (vₓ, v_{y}) represents relative speeds in a vertical direction and a horizontal direction of the cluster.

8. The system of claim 7, wherein the heading angle is estimated through following Equation 3,
$$Heading angle = arctan ( \frac{{v}_{abs , y}}{{v}_{abs , x}} ) . \qquad [ Equation 3 ]$$

9. The system of claim 6, wherein the third step is performed through following Equation 4,
$${X}_{center point} = \frac{{V}_{1 , x} + {V}_{3 , x}}{2} \qquad [ Equation 4 ]$$
$${Y}_{center point} = \frac{{V}_{1 , y} + {V}_{3 , y}}{2}$$
(in which, V₁=ƒ(P_{cp}, w₁, l₁, θ), V₃=ƒ(P_{cp}, w₂, l₂), and ƒ(point, width, length, heading angle) is a function for extracting four vertexes of a virtual rectangle having the length, the width, and the heading angle, based on the detection point included in the cluster.

10. The system of claim 2, wherein an angle between P̅_̅{̅c̅p̅}̅P̅ᵢ̅ and an x axis is selected as a candidate of the heading angle through following Equation 5, and the heading angle (θᵢ) is estimated based on Pᵢ for minimizing a sum of distances between detection points, in relation to the cluster classified as being in the stopped state,
$${θ}_{i} ( Heading angle ) = arctan ( \frac{{y}_{i} - {y}_{closeat point}}{{x}_{i} - {x}_{closeat point}} ) \qquad [ Equation 5 ]$$
$$Sum of distances between detection points = {\sum }_{i = 1}^{n - 2} {d}_{i} ( n : number of detection points ) , and$$
$$\hat{ι} = {arg min}_{i} ( {\sum }_{i = 1}^{n - 2} {d}_{i} ( n : number of detection points ) )$$
(in which P_{cp} is a closest point, Pᵢ is an i-th detection point, and the sum of the distances between the detection points is determined except for P_{cp} and Pᵢ).

11. A method for recognizing a position and a shape of a cluster for autonomous driving, and recognizing an object based on a plurality of detection points input from an artificial intelligence (AI) module and an autonomous driving sensor, the method comprising:
a first step for clustering the plurality of detection points into at least one cluster, determining whether a number of the detection points belonging to the cluster is greater than or equal to ‘n’, wherein the ‘n’ is an integer number, and determining whether an absolute velocity of the cluster is greater than or equal to a threshold value, by the AI module;
a second step for estimating a heading angle of the object corresponding to the cluster, based on the absolute velocity or determining a constant heading angle, and for estimating a length and a width of the corresponding object based on a shape of distribution of the detection points, or determining a constant length and a constant width, by the AI module; and
a third step for estimating a position of the cluster, based on P-Box information for the cluster, by the AI module.

12. The method of claim 11, wherein the autonomous driving sensor includes at least one radar, and
wherein the object is classified as being in a moving state, based on that the absolute velocity of the cluster is greater than or equal to the threshold value, and as being in a stopped state, based on that the absolute velocity of the cluster is less than the threshold value.

13. The method of claim 12, wherein the second step includes a step for estimating the constant heading angle, the constant length, and the constant width as a shape of the cluster, based on that a number of the detection points is less than ‘n’.

14. The method of claim 13, wherein the third step includes a step for estimating an average on coordinates of the detection points belonging to the cluster as the position of the cluster, based on that the number of the detection points is less than ‘n’.

15. The method of claim 12, wherein the second step includes a step for estimating the heading angle, the length, and the width, based on a distribution form of the detection point with respect to the cluster classified as being in the stopped state.

16. The method of claim 11, wherein the estimating of the length and the width of the corresponding object, based on a distribution form of the detection point is performed through following Equation 1,
$$Length = {l}_{1} + {l}_{2} \qquad [ Equation 1 ]$$
$$Width = {w}_{1} + {w}_{2}$$
$$( in which , {l}_{1} = {\{ max ( \{ \begin{matrix}{x}_{i}^{′} & if {x}^{′} \geq 0 \\ 0 & if {x}^{′} < 0\end{matrix} ) \}}_{i = 1}^{n} , {l}_{2} = {\{ max ( \{ \begin{matrix}\vert {x}_{i}^{′} \vert & if {x}^{′} < 0 \\ 0 & if {x}^{′} \geq 0\end{matrix} ) \}}_{i = 1}^{n} ,$$
$${w}_{1} = {\{ max ( \{ \begin{matrix}{y}_{i}^{′} & if {y}^{′} \geq 0 \\ 0 & if {y}^{′} < 0\end{matrix} ) \}}_{i = 1}^{n} , {w}_{2} = {\{ max ( \{ \begin{matrix}\vert {y}_{i}^{′} \vert & if {y}^{′} < 0 \\ 0 & if {y}^{′} \geq 0\end{matrix} ) \}}_{i = 1}^{n} .$$

17. The method of claim 11, wherein the absolute velocity is determined through following Equation 2,
$$Cluster absolute velocity = cluster relative velocity ( i . e . , the above mentioned {v}_{x} , {v}_{y} ) + absolute velocity of the host vehicle , \qquad [ Equation 2 ]$$
$$in which {v}_{x} , and {v}_{y} has a relationship of$$
$$[ \begin{matrix}{v}_{r , 1} \\ {v}_{r , 2} \\ ⋮ \\ {v}_{r , N}\end{matrix} ] = [ \begin{matrix}cos ( {θ}_{1} ) & sin ( {θ}_{1} ) \\ cos ( {θ}_{2} ) & sin ( {θ}_{2} ) \\ ⋮ & ⋮ \\ cos ( {θ}_{N} ) & sin ( {θ}_{N} )\end{matrix} ] [ \begin{matrix}{v}_{x} \\ {v}_{y}\end{matrix} ] , ‘ {v}_{r , i} ’$$
is a gaze velocity of an i-th detection point, θᵢ is an azimuth angle of the i-th detection point, and (vₓ, v_{y}) represents relative speeds in a vertical direction and a horizontal direction of the cluster.

18. The method of claim 17, wherein the heading angle is estimated through following Equation 3,
$$Heading angle = arctan ( \frac{{v}_{abs , y}}{{v}_{abs , x}} ) . \qquad [ Equation 3 ]$$

19. The method of claim 16, wherein the third step is performed through following Equation 4,
$${X}_{center point} = \frac{{V}_{1 , x} + {V}_{3 , x}}{2} \qquad [ Equation 4 ]$$
$${Y}_{center point} = \frac{{V}_{1 , y} + {V}_{3 , y}}{2}$$
(in which, V₁=ƒ(P_{cp}, w₁, l₁, θ), V₃=ƒ(P_{cp}, w₂, l₂), and ƒ(point, width, length, heading angle) is a function for extracting four vertexes of a virtual rectangle having the length, the width, and the heading angle, based on the detection point included in the cluster, and center point refers to a central point of the virtual rectangle.

20. The method of claim 12, wherein an angle between P̅_̅{̅c̅p̅}̅P̅ᵢ̅ and an x axis is selected as a candidate of the heading angle through following Equation 5, and a heading angle (θᵢ) is estimated based on Pᵢ for minimizing the sum of distances between detection points, in relation to the cluster classified as being in the stopped state,
$${θ}_{i} ( Heading angle ) = arctan ( \frac{{y}_{i} - {y}_{closeat point}}{{x}_{i} - {x}_{closeat point}} ) , \qquad [ Equation 5 ]$$
$$Sum of distances between detection points = {\sum }_{i = 1}^{n - 2} {d}_{i} ( n : number of detection points ) , and$$
$$\hat{ι} = {arg min}_{i} ( {\sum }_{i = 1}^{n - 2} {d}_{i} ( n : number of detection points ) )$$
P_{cp}PᵢP_{cp}Pᵢ (in which is a closest point, is an i-th detection point, and the sum of the distances between the detection points is determined except for and).
P_{cp}PᵢP_{cp}Pᵢ
